(19) United States
(12) Patent Application Publication
(10) Pub. No.: US 2005/0149951 A1
(43) Pub. Date: Jul. 7, 2005

(54) Accessing accessory of a device

(76) Inventors: Juha Uola, Tampere (FI); Kimmo Loytana, Tampere (FI); Kari Systa, Tampere (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/749,873

(22) Filed: Dec. 31, 2003

(51) Int. Cl. G06F 9/46

(52) U.S. Cl. 719/328

(57) ABSTRACT

The invention relates to an electronic device comprising an interface for providing a connection with an accessory. The accessory includes a library for enabling said electronic device to use the accessory. The electronic device further comprises means for providing said library available to the electronic device. The invention also relates to a mobile communication device and a system. The invention further relates to a method for accessing accessory functionality to applications of an electronic device; a computer program product for implementing the method; and a method for providing access to an accessory of an electronic device.

### FIELD OF THE INVENTION

The invention is related to accessing accessory functionality to applications. The applications can use a library for accessing the accessory features. The invention is especially related to, but not limited to, Java libraries.

### BACKGROUND OF THE INVENTION

The number of the accessories for mobile devices is increasing. In this description the term accessory means an additional device which brings one or more new features to the mobile device when the accessory is brought into communication connection with the mobile device. Many such accessories need a library or driver through which it is used by applications, such as Java applications, running in the mobile device. The library is built to enable access and control of the accessory. Such libraries are often stored in the mobile device for different accessories by, e.g., the manufacturer of the mobile device. There may exist a number of such libraries stored in the mobile device to assure that different kinds of accessories can be used by the mobile device. However, the user may use only a limited number of accessories, if any, and different users may use different accessories. Therefore, the libraries which are permanently stored in the mobile device and which are not needed by the user unnecessarily reserve the often quite restricted storage capacity of the mobile device. There exist several techniques to solve this problem, but all have some limitations.

Currently the library that utilizes the accessory needs to be put into the mobile device already in the manufacturing phase. However, all the possible accessories connectable to the mobile device are not necessarily known in this phase. To let the applications use a previously unknown accessory the user would need to be able to update the mobile device software platform himself to support new accessory. The user would need to identify which library is to be used with the new accessory. The library could be downloaded from an accessory manufacturer web server or from a storage media that came with the accessory. A download from the web requires a network connection and a device capable of downloading the library.

Using shared or dynamically linked libraries is a well-known technique in the computer industry. In this case the libraries reside on a computer storage medium or in some cases they are loaded from the network. There are also other well-known solutions of which some examples are:
discovering and using networked services with the so called Jini network technology;
connecting devices into a Windows environment using Universal Plug-n-Play (UPnP)
downloading applications dynamically from the web to a device and executing them;
attaching a memory stick, a memory card etc. to a device and loading resources (e.g. pictures, music) from the memory stick to the device and/or from the device to the memory stick; and
attaching memory stick, a memory card etc. that holds applications to a device, loading those applications and executing them on the device.

However, there are limitations and problems with the above solutions. Jini technology is heavyweight and targeted for integrating networked services. UpnP is Windows-specific and does not allow code to be downloaded and executed on the device. Downloading applications or resources (e.g. pictures, music) is different from downloading libraries that enable the use of the accessory for all applications.

If Java libraries for all possible (future) accessories is put to the device Java platform, this has a negative effect on the memory consumption of the device. In addition, applications need to have ways to identify which accessories are actually in use and which only have a placeholder library available.

There may exist compatibility and interoperability problems between an accessory and libraries if the development of the accessory is not combined with the development of the libraries. Moreover, if the accessory is developed after the development of the libraries it may happen that the libraries do not support all the properties of the accessory.

Java application life cycle consists of user locating the application, downloading the application to a device, installing it, using it, and removing it from the device. Application download typically takes place e.g., over the air from a server, or locally from a PC via cable or wireless link. It is possible to use an accessory for enhancing the mentioned application life cycle phases and improving user experience.

The European patent publication EP 1 347 623 discloses downloading of application software for an accessory device to a mobile device. The application software is stored on the memory of the accessory. the application software can be platform independent Java applets or Symbian applications. The mobile device might comprise a Java VM (virtual machine), e.g., a kJava VM or a MIDP Java VM, or a Symbian OS (Operating System). When the accessory is connected to the mobile device it is detected and the downloading of the application software from the accessory is initiated. When the application software is downloaded to the mobile device it can be started and used for controlling the accessory and exchanging information with the accessory. The connection and the information transfer between the mobile device and the accessory is conducted through a smart accessory manager. It has built in application programming interfaces (APIs) for different kinds of connections. By using this downloading method the downloaded application can use the properties of the accessory from which the application was downloaded. This method, however, does not automatically enable other applications running on the mobile device to use the properties of the accessory.

### SUMMARY OF THE INVENTION

The invention is related to bringing an application programming interface (API) for accessing accessory functionality to applications running on a device. The applications can use a library for accessing the accessory features. Also the library is installed to the device from the accessory. The library is built to enable access and control of the accessory. Since the library becomes available when a physical accessory is available the applications using this library can have guaranteed access to the accessory.

In this invention the solution is that also the API and the implementation of the API are brought to the device within the accessory. When this kind of accessory is attached to the device any application can use the accessory through the API, not only those applications which are especially designed for the accessory in question.

One central idea of the present invention is that the application library brought by the accessory is built on top of the accessory functionality. When bringing the accessory with the library to the device, any authorized application running on the device can access the accessory functionality via the API that the library offers.

According to one aspect of the present invention there is provided an electronic device comprising
an interface for providing a connection with an accessory; said accessory comprising
   a library for enabling said electronic device to use the accessory
      wherein the electronic device further comprises means for providing said library in such a way that it is available to the electronic device.

According to a second aspect of the present invention there is provided an accessory comprising
a library for enabling an electronic device to use the accessory; and
an interface for providing a connection with the electronic device.

According to a third aspect of the present invention there is provided a system comprising:
an electronic device;
an accessory;
a library in said accessory for enabling an electronic device to use the accessory;
an interface for providing a connection between said electronic device and said accessory; and
means for providing said library in such a way that it is available to the electronic device.

According to a fourth aspect of the present invention there is provided a method for accessing an accessory by an electronic device, comprising:
including a library in said accessory for enabling an electronic device to use the accessory;
providing a connection between said electronic device and said accessory; and
providing said library in such a way that it is available to the electronic device.

According to a fifth aspect of the present invention there is provided a computer program product for storing a computer program comprising machine executable steps for accessing an accessory by an electronic device, the accessory including a library for enabling an electronic device to use the accessory, wherein the computer program comprises machine executable steps for:
providing a connection between said electronic device and said accessory; and
providing said library in such a way that it is available to the electronic device.

According to a sixth aspect of the present invention there is provided a method for providing access to an accessory of an electronic device, the method comprising
storing a library in the accessory for enabling an electronic device to use the accessory;
providing a connection between said electronic device and said accessory; and
providing said library in such a way that it is available to the electronic device.

The invention provides a more convenient mechanism for making accessory functionality available for Java applications running on the device. Support for accessories does not have to be built in the device in a manufacturing phase.

In a case where accessories that require a software update to the device in order to operate, this invention eases the update process. The process is close to automatic and the user does not have to be bothered with downloading and library and accessory compatibility issues.

If the provided library implements a (standardized) API, all the applications built on top of this API become executable on the device.

This invention is more lightweight than Jini and also implementable on embedded devices with a small amount of memory and is not limited to Java technology.

One of the main benefits of the invention is that all applications of the mobile device have the possibility to use the services of the accessory.

The accessory can be, for example, a GPS (Global Positioning System) accessory. When it is attached to the device the device can load the API and the implementation automatically. When the API and implementation are loaded to the device any application that wants to use GPS information can ask for it from the GPS accessory via the API. Of course the maximum benefit can normally be achieved if the API is one of the standardized API's like in the example above the Location API for J2ME. Another non-limiting examples of accessories are temperature, tilt or accelerator sensors, etc.

### DESCRIPTION OF THE DRAWINGS

In the following the invention will be described in more detail with reference to the attached drawings, in which

FIG. 1 illustrates the use of the accessory library in a device,

FIG. 2 shows an example embodiment of the device according to the present invention, and

FIG. 3 shows as a reduced block diagram an example embodiment of a system according to the present invention, and

FIGS. 4a-4c show as flow diagrams some steps of an example embodiment of a method according to the present invention.

### DETAILED DESCRIPTION OF THE INVENTION

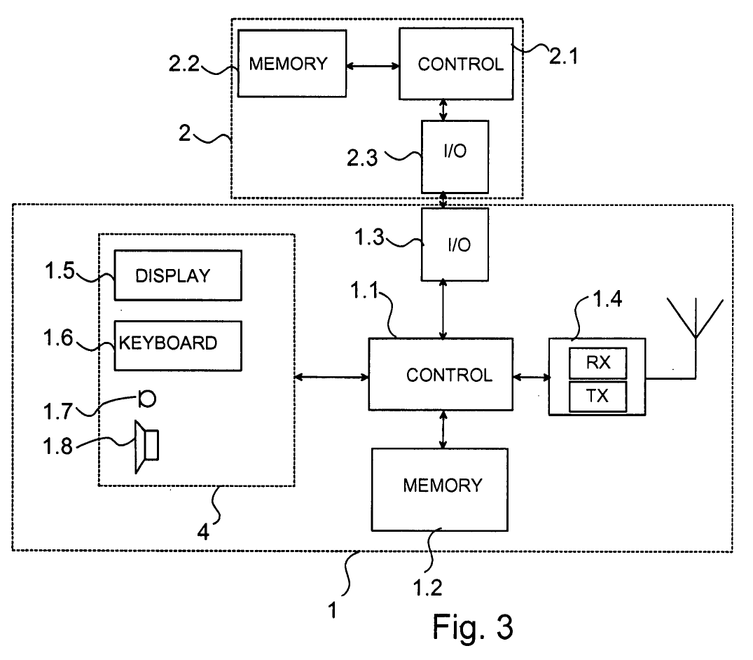

In the following the invention will be described using a Java library as an example of libraries but the invention is not limited to the Java environment and to Java libraries only. Other possible environments are, for example, BREW™ from Qualcomm® and .NET™ Framework from Microsoft. It is also assumed that the device 1 has a Java platform (typically J2ME™ MIDP; The Java™ 2 platform, Micro Edition, Mobile Information Device Profile) with the additional capability to dynamically install libraries to the device 1. The device 1 can be any device capable of running applications and provided by a connecting means for connecting an accessory 2 with the device 1. FIG. 3 shows as a block diagram of an example of such a device 1. The device 1 comprises a control unit 1.1 for, inter alia, controlling the operations of the device 1 and for running applications on the device 1. The control unit 1.1 can be implemented as separate circuits, such as one or more processors, or as an integrated circuit, such as an ASIC (Application Specific Integrated Circuit). The device also comprises a memory 1.2 for storing applications, APIs, libraries, control software, data etc. The memory 1.2 may consist of a read-only memory and a random access memory. There is also provided an interface 1.3 in the device 1 for providing a connection with an accessory 2. The interface 1.3 may comprise wired connecting means and/or wireless connecting means. In addition to the interface 1.3 the device 1 may comprise communication means 1.4, such as mobile communication means, for performing communication tasks with a communication network and/or with another device (not shown). The device 1 further comprises a user interface comprising, for example, a display 1.5, a keyboard 1.6, a microphone 1.7 and/or a loudspeaker/headphone 1.8.

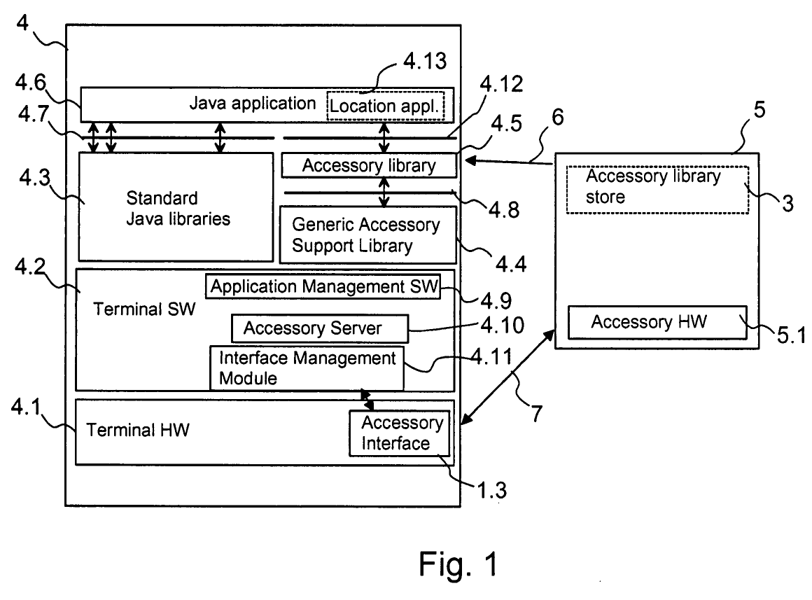

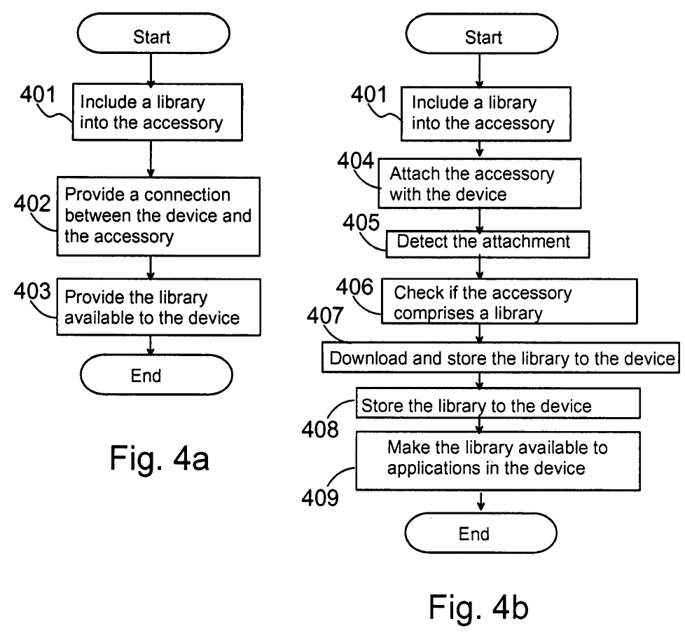

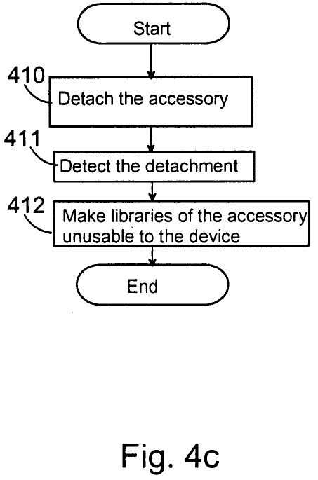

The accessory 2 comprises a control unit 2.1 for controlling the operation of the accessory 2. The accessory 2 also comprises a memory 2.2 to store (block 401 in FIGS. 4a and 4b), inter alia, a library 3 (FIG. 1) or libraries developed for the accessory 2. There is also an interface 2.3 for connecting (block 402 in FIG. 4a) the accessory 2 with the device 1.

The interface 1.3 of the device 1 and the interface 2.3 of the accessory 2 may comprise connectors if the connection between the device 1 and the accessory 2 is a wired connection. If the connection is wireless, both said interfaces 1.3, 2.3 comprise a transmitter and a receiver capable of communicating using e.g. radio communication or optical communication.

In the following the method according to an example embodiment of the present invention will be described in more detail with further reference to the flow diagrams of FIGS. 4a through 4c. First, a wired connection between the device 1 and the accessory 2 is assumed. It is also assumed that the device 1 is switched on when the accessory 2 is attached 404 to the device 1 and that the library or libraries will be downloaded 407 from the accessory 2 to the device 1. In the device 1 the interface 1.3 detects 405 the attachment of the accessory 2. The detection may be based on sensing voltage levels on a detection line of the interface 1.3 or receiving a message from the accessory 2 via a data bus of the interface 1.3. After the attachment of the accessory 2 is detected the device 1 discovers the accessory 2 and identifies it. The identification may be based, for example, on receiving a message from the accessory 2 including identification information, or the device 1 can read an identification data from the memory 2.2 of the accessory 2. The device 1 also discovers 406 if there are one or more downloadable libraries 3 stored in the accessory 2. If it is discovered that there is at least one downloadable library 3 stored in the accessory 2, the library 3 can be automatically installed to the device 1 or the device 1 may ask confirmation for the downloading from the user of the device 1.

The downloading 407 can be performed, for example, as follows. The device 1 begins to communicate with the accessory 2 for downloading the library 3 or libraries from the accessory 2 to the device 1. The attachment of the accessory 2 with the device 1 and communication between them can be based on any suitable standard or non-standard communication method which is applicable for transferring the library data. The downloaded library 3 is received in the device 1 and stored 408 in the memory 1.2 of the device. Examples of standard connections are Bluetooth, USB and I²C.

If, on the other hand, the accessory 2 was connected to the device 1 when the device 1 was powered off, the same kind of steps are still performed. At some stage the device 1 detects 405 that it is connected with the accessory 2. The device discovers the accessory 2 and identifies it and downloads 407 the library 3 or makes it available for applications directly from the accessory 2.

The relationship between the device 1 and the accessory 2 is shown in FIG. 1. In the device 1 the hardware (HW) and the software (SW) can be regarded as providing a platform 4 for the operation of the device 1.

The platform 4 of the device 1 comprises a hardware section 4.1, a software section 4.2 including control software and applications of the device 1, standard Java libraries 4.3 and generic accessory support library 4.4. The platform 4 of the device 1 also comprises Java application section 4.6 for storing Java applications, and an accessory library 4.5 for storing libraries 3 downloaded from the accessory 2. There is also provided a standardized Java API 4.7, a Java accessory library API 4.12 that is implemented by the downloaded accessory library and an internal Java API 4.8. The standardized Java API 4.7 is used as an interface between standard Java libraries and Java applications. The Java accessory library API 4.12 provides accessory functionality for the application. The internal Java API 4.8 is used as an interface between the accessory library 4.5 and the generic accessory support library 4.4 to access the accessory functionality. The platform 4 of the device 1 also includes an application management software (AMS) 4.9 as a part of the Java system that controls execution, installation and removal of Java applications. The platform 4 of the device 1 further includes an accessory server 4.10 for controlling at least the detection of attachment and detachment of the accessory 2. The accessory server 4.10 has access to the desired parts of the hardware 4.1 for performing the detection, for example, by examining the status of the interface 1.3.

The accessory platform 5 comprises a hardware section 5.1 and the library 3.

In the installation phase 6 of the library 3 the accessory 2 can, for example, offer the following information to the device 1: library location, name, size, version and vendor. This information is used by the device Java platform 4 for installing the library 3.

There are also some other issues that should be considered when utilizing the libraries of the accessory 2 according to the present invention. There may be more than one library 3 available on the accessory 2, wherein the platform 4 of the device 1 should be able to manage all of them. The accessory 2 may also include applications that can be loaded to the device. Applications may require that the accompanied libraries are installed before they start to execute. In that case the platform 4 of the device 1 should first make 409 the necessary libraries 3 available to the application before starting to execute the application.

There may be some restrictions so that some (unauthorized) applications are not allowed to use the accessory library 3. This can be managed by, for example, Java platform security settings. If the accessory is to be used, e.g., with several different phone models with different Java platforms, some Java platforms may already include the library 3 that the accessory 2 brings with it. The Java platform should also be able to handle such situations. In one embodiment of the invention the dynamically installed Java library 3 is using existing internal Java API 4.8. The existing Java APIs 4.7, 4.8 also include already installed dynamic libraries.

Let's suppose that there is an application running on the device 1 which wishes to use the library 3 of the attached accessory 2. The platform 4 checks the status of the library 4.5 and allows the use if the accessory 2 is available. The library 4.5 of the accessory 2 may communicate 7 with the accessory 2 via the generic accessory support library 4.4.

When the accessory 2 is detached 410 (FIG. 4c) from the device 1, the interface 1.3 of the device detects 411 that. The device 1 may then make 412 all the libraries 4.5 which were downloaded from the accessory 2 unusable to the applications of the device 1. This may be performed by removing from the memory 1.2 the libraries 4.5 which were downloaded from the accessory 2 and/or by setting a flag or some other indicator to a state indicating the unusability of the libraries 4.5.

In another embodiment of the present invention libraries 3 of the accessory are not downloaded to the device 1 but they are made available to the device 1 by using other means. This can be performed, for example, so that the accessory 2 is powered up and connected either by wired or wireless manner with the device 1. When the device 1 has detected the existence of the accessory 2 it performs the similar identification step and discovers whether the accessory 2 comprises a library 3 which the applications of the device 1 can use. The device 1 adds information on such library 3 or libraries to the platform 4. When the library 3 is accessed by an application running on the device 1 the device 1 and the accessory 2 communicate to make the library 3 of the accessory 2 accessible to the application as if the library 3 were installed on the platform 4 of the device 1. This approach may require that the Java platform be modified in the installation phase to find the library 3 from the accessory 2 during run-time.

The details of the method according to the present invention will be described in more detail in the following implementation examples.

Implementation Alternatives

There are several possibilities to implement this invention. One typical scenario would be a mobile phone as a device 1 with an accessory 2 that is attached to the phone. The device 1 has a Java platform (typically J2ME MIDP) with the additional capability to dynamically install libraries 3 to the platform 4.

In an example implementation the attaching and detaching of accessories 2 dynamically is allowed without requiring restarting of the device 1, the Java platform 4 or even the application. In this kind of implementation the library/libraries 3 offered by the accessory 2 are transparently installed to the Java platform 4 when the accessory 2 is attached and, respectively, uninstalled from the Java platform when the accessory 2 is detached. In one typical implementation the availability of the possible dynamic libraries 3 is checked when the application starts. If the required libraries 3 are available, the application may start executing. One possibility to provide the application information about the availability of the library 3 would be the Java platform which is modified so that it comprises means for the applications to ask about the currently available libraries.

Example Implementation

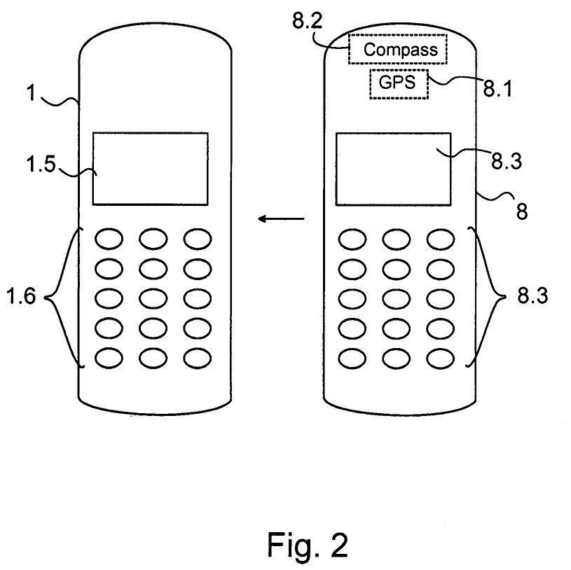

An example of a possible dynamic library implementation scenario with a GPS accessory is described in the following with reference to FIG. 2.

The accessory 2 is a cover 8 of a device 1 including a GPS receiver 8.1 and a compass 8.2. The display 1.5 and keyboard 1.6 of the device 1 are used for the user interface, and the memory 1.2 is used for storing location data. In this example the cover 8 does not have any buttons or displays but only holes 8.3 on the respective locations of the display 1.6 and the keys of the keyboard 1.5 so that the cover 8 fits on the top of the device 1.

First Discovery

When the cover 8 is attached to the device 1, an interrupt is raised and an event is sent to the accessory server 4.10. The accessory server 4.10 initializes an interface management module 4.11 which is used for communicating with the cover 8. The interface management module 4.11 is arranged to provide a low-level interface to the accessory interface 1.3 and it is used, for example, to interpret messages received from the accessory 2 by the accessory interface 1.3, to form messages to be transmitted to the accessory 2 by the accessory interface 1.3, and to detect the attachment and detachment of the accessory 2 on the basis of physical information of the accessory interface 1.3. After the initialization is performed the accessory server 4.10 discovers the type of the cover 8 by communicating via the interface management module 4.11. The device 1 also discovers if it comprises any downloadable libraries 3. When the device 1 has determined that the accessory is a cover 8 and that there is at least one library 3 to download the device performs the downloading of the library 3 (or makes the library 3 of the cover accessible to the applications of the device by some other method as was disclosed above). In this example the device 1 includes a location application 4.13. The location application 4.13 may have been installed from a removable storage media, from a communication network, by the manufacturer of the device etc. It should be realized that the GPS receiver 8.1 of the cover can be used by starting the location application of the device 1 or any other location application manually from an applications menu of the phone or automatically when the device 1 has detected the attachment of the cover 8 and performed the installation of the library 3 of the cover 8.

The location application 4.13 may, for instance, be built on top of a Location API for J2ME. The cover 8 can add Location API support to the device 1 that has not before had any location functionality, nor an API for accessing it.

If the cover 8 has an attribute (e.g., JavaRequiredAPI) informing that the operation of the cover 8 requires a Java API application, management software 4.9 checks the attribute value against the currently available APIs in the device 1. It is assumed that application management software 4.9 keeps track of the available APIs the same way it keeps track of the available MIDlets. If such API is already present, application management software 4.9 will move to an application provisioning phase. If the API is not present, application management software 4.9 needs to do API provisioning before it can continue to application provisioning. The location of the required API library 3 can be read from a JavaAPIImplementation attribute, which points to an appropriate jar file (Java archive) in the file system of the cover 8.

If the cover 8 has an attribute JavaControlApplication, application provisioning takes place, for example, in the following way: application management software 4.9 starts the application provisioning by sending a message install(url) to the application management software server. The url of the application points to files in the file system of the cover 8.

As a summary, the discovery finds, e.g., the following attributes from the cover:

| Attribute | Value | Notes |
|---|---|---|
| FileSystem1 | “Flash file system <F> at...” | |
| JavaRequiredAPI | “LocationAPI” | Value is |
| | | checked |
| | | against existing |
| | | phone APIs |
| JavaAPIImplementation | <F>: LocationAPI_Impl.jar | |
| JavaControlApplication | <F>: LocationMidlet.jar | |

API Provisioning and Installing

If the device 1 does not have an existing Java Location API, application management software 4.9 needs to configure the classloader of the VM to start using the location API library from the accessory memory 2.2. JavaAPIImplementation attribute value is appended to VM “classpath” (depending on implementation this may be something else). The application management software 4.9 is notified about the new API and “LocationAPI” entry is added to the list of available APIs of the application management software 4.9.

If the device 1 already has a Java Location API present by default, replacing the device Location API implementation with the Location API implementation of the cover 8 may not be possible due to security restrictions. In addition, replacing the device 1 Location API implementation may not be feasible, if the present implementation is using device features that would not be available with the Location API implementation of the cover 8.

Application Provisioning and Installing

The application management software 4.9 reads the Manifest that has, e.g., the following attributes:

| Attribute | Values |
|---|---|
| MIDlet-Name | LocationMidlet |
| MIDlet-Version | 1.0 |
| MIDlet-Vendor | Nokia |
| MIDlet-Icon | <F>: LocationMidlet.png |
| MIDlet-Description | The use of this cover requires installation |
| | of a LocationMidlet application. After |
| | installing you are able to view location |
| | data and see your location on a map. |
| MIDlet-1 | LocationMidlet, <F>: LocationMidlet.png, |
| | com.nokia.phone.accessories. |
| | LocationMidlet.Main. |
| MicroEdition-Profile | MIDP-2.0 |
| MicroEdition-Configuration | CLDC-1.1 |
| API-Extensions | javax.microedition.location |

After reading the Manifest, the application management software 4.9 checks that minimum profile, configuration and extension requirements are met. If so, the application management software 4.9 shows the user the content of the attribute MIDlet-Description and asks for a permission to continue. If the user accepts to continue, the installation continues as follows: The LocationMidlet is inserted to the applications or accessories menu. If the JAR is accessible via the terminal 1 file system, it does not need to be copied to the memory 1.2 of the device 1. Instead, the JAR in the cover 8 can be used for classloading during the execution.

Subsequent Discoveries

The discovery process for the cover discoveries are assumed to be the same since it is only run when the cover 8 is installed, and changing the cover 8 will make the API library 3 in-accessible and remove references to them.

Application Execution

The application execution is started when the user selects the MIDlet from the applications menu. The location application MIDlet shows a map and in the middle the user's current location. The location application uses location information of the GPS receiver 8.1 of the cover 8 and compass bearing information of the compass 8.2 of the cover 8. When the user location changes, the map is updated accordingly keeping the user location always in the middle of the screen. If the user turns, the map rotates so that the map north is pointing substantially to the compass north heading. This makes navigation easier for an average person. However, it is possible that the application 4.13 shows a static map with an arrow pointing to the user heading. It should be noted here that the compass bearing information is different from the GPS direction data that can only show the direction of movement.

The location application 4.13 can download maps from dedicated servers (not shown) based on city, street address, coordinates and/or other criteria. Waypoints can be set by the user or received from a server based on some search criteria (e.g., restaurants in the neighbourhood), and the location application 4.13 is able to show direction and distance to a certain waypoint. Waypoints and maps can be stored to a record management system (RMS). An additional feature could be that the user could ask for a route map from the server based on some waypoints. Text-based route instructions could be returned with the route map and they could be used the same way as in car navigation systems.

Since the locator cover 8 includes a Java Location API implementation, it is possible to download and execute any other third-party MIDlets that are based on this API.

Communication/Control Protocol

The location application 4.13 uses Java Location API for obtaining info from the cover 8.

The Java Location API internal implementation uses a suitable communication protocol (such as some I²C-based protocol) for communicating with the cover 8. This requires that the Java environment of the device 1 is able to offer such Java protocol API for the downloaded Java Location API implementation.

Removal of the Accessory

The accessory server 4.10 also notices the removal, for example, because of an interrupt generated by the hardware of the device 1. On removal, the application management software 4.9 is notified that the Java Location API implementation is no longer available and installed location MIDlets cannot execute (ClassNotFoundException or VM internal error is thrown). The application management software 4.9 removes the “LocationAPI” entry from its list of available APIs.

The above mentioned cover 8 was only a non-limiting example of the accessory 2. As another non-limiting example of the accessory 2 is a battery of the device 1 comprising a sensor, a receiver etc.

Updating the Accessory

In some situations it may be desirable to update the library and/or the application programming interface of the accessory 2, for example, to a newer version. The updating procedure can be performed, for example, so that the device 1 downloads the updated version from a network and stores it to the accessory 2. The accessory 2 may comprise means to check that there is enough storage capacity in the memory 2.2 of the accessory for the new version because the size of the downloaded version of the library and/or the application programming interface may have increased. The accessory 2 may also comprise means for enabling the device 1 to write the new version of the library and/or the application programming interface to the memory 2.2 of the accessory.

In view of the foregoing teachings, it should be evident to those of skill in that art that the present invention is not limited to the above described embodiments but it can be varied within the scope of the attached claims.

1. An electronic device comprising:
an interface for providing a connection with an accessory; said accessory comprising
a library for enabling said electronic device to use the accessory; wherein the electronic device further comprises means for providing said library available to the electronic device.

2. The electronic device according to claim 1, said accessory further comprising an application programming interface, wherein the electronic device further comprises means for providing said application programming interface available to the electronic device.

3. The electronic device according to claim 1, comprising interface means for providing said library available to the electronic device directly from said accessory.

4. The electronic device according to claim 1, comprising an interface management module for downloading said library to the electronic device.

5. The electronic device according to claim 1, said library and said application programming interface providing a connection between said accessory and an application loaded to the electronic device.

6. The electronic device according to claim 1, said interface comprising detection means for detecting an attachment of the accessory to the electronic device.

7. The electronic device according to claim 1, said interface comprising detection means for detecting a detachment of the accessory from the electronic device.

8. The electronic device according to claim 7, comprising an interface management module for disabling a connection between an application loaded to the electronic device and said library when the detachment of the accessory is detected.

9. The electronic device according to claim 1, the accessory further comprising at least one application, wherein the electronic device comprises means for downloading said at least one application from the accessory to the device.

10. The electronic device according to claim 2 comprising means for making said application programming interface available for at least one application loaded to the electronic device before starting the execution of said application.

11. An accessory comprising
a library for enabling an electronic device to use the accessory; and
an interface for providing a connection with said electronic device.

12. The accessory according to claim 11, further comprising a functionality that is usable for applications on said electronic device.

13. The accessory according to claim 11, further comprising an application programming interface.

14. The accessory according to claim 11, comprising interface means for providing said library available to said electronic device directly from the accessory.

15. The accessory according to claim 11, wherein said library is of Java, C, C++, C# or Visual Basic code.

16. The accessory according to claim 11, said interface comprising means for indicating an attachment of the accessory to the electronic device.

17. The accessory according to claim 11, said interface comprising means for indicating a detachment of the accessory from the electronic device.

18. The accessory according to claim 11, further comprising at least one application to be loaded to the electronic device.

19. A system comprising:
an electronic device;
an accessory;
a library in said accessory for enabling said electronic device to use the accessory;
an interface for providing a connection between said electronic device and said accessory; and
means for providing said library available to the electronic device.

20. The system according to claim 19, said accessory further comprising an application programming interface, wherein the system further comprises means for providing said application programming interface available to the electronic device.

21. The system according to claim 19, comprising interface means for providing said library available to the electronic device directly from said accessory.

22. A method for accessing an accessory by an electronic device, comprising:
including a library in said accessory for enabling said electronic device to use the accessory;
providing a connection between said electronic device and said accessory; and
providing said library available to the electronic device.

23. The method according to claim 22, the accessory further comprising an application programming interface, wherein the method further comprises providing said application programming interface available to the electronic device.

24. The method according to claim 22, comprising providing said library available to said electronic device directly from the accessory.

25. The method according to claim 22, the accessory comprising a functionality, wherein the method further comprising providing said functionality for use of said electronic device by means of said library.

26. The method according to claim 22, comprising detecting an attachment of the accessory to the mobile communication device.

27. The method according to claim 26 comprising downloading said library from the accessory to the mobile communication device when the attachment of the accessory is detected.

28. The method according to claim 22, comprising providing a connection between an application loaded to the electronic device and said accessory.

29. The method according to claim 22, comprising detecting a detachment of the accessory from the device.

30. The method according to claim 29 comprising disabling a connection between an application loaded to the electronic device and said accessory when the detachment of the accessory is detected.

31. The method according to claim 22, the accessory comprising at least one application, wherein the method comprising downloading said at least one application from the accessory to the device.

32. The method according to claim 23 comprising making said application programming interface available for at least one application loaded to the electronic device before starting the execution of said application.

33. A computer program product for storing a computer program comprising machine executable steps for accessing an accessory by an electronic device, the accessory including a library for enabling said electronic device to use the accessory, wherein the computer program comprises machine executable steps for:
providing a connection between said electronic device and said accessory; and
providing said library available to the electronic device.

34. A method for providing accessing an accessory of an electronic device, the method comprising
storing a library to the accessory for enabling said electronic device to use the accessory;
providing a connection between said electronic device and said accessory; and
providing said library available to the electronic device.

35. The method according to claim 34, further comprising storing an application programming interface to the accessory, and providing said application programming interface available to the electronic device.
